(19) United States
(12) Patent Application Publication
(10) Pub. No.: US 2007/0156786 A1
(43) Pub. Date: Jul. 5, 2007

(54) Method and apparatus for managing event logs for processes in a digital data processing system

(75) Inventors: Dawn Marie May, Mantorville, MN (US); Angela Mae Newton, Oronoco, MN (US); William Daniel Tarara, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/316,284

(22) Filed: Dec. 22, 2005

(51) Int. Cl. G06F 17/30

(52) U.S. Cl. 707/204

(57) ABSTRACT

Data structures which maintain event records for executing processes are maintained in a persistent form after the process which created each respective such event record data structure is terminated. The event record data structures are eventually de-allocated, preferably by an automated process which de-allocates the event record data structures after a pre-specified time period. A log formatted in human-readable form is generated, if at all, on demand of a user after completion of the process, and before de-allocation of the event record. By deferring the decision to generate a human-readable log, unnecessary event log generation and potential contention for system resources is avoided.

### FIELD OF THE INVENTION

The present invention relates generally to digital data processing, and more particularly to the management of data structures for logging events occurring during the execution of software processes in a digital computer system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises hardware in the form of one or more central processing units (CPU) for processing instructions, memory for storing instructions and other data, and other supporting hardware necessary to transfer information, communicate with the external world, and so forth. From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Programs which direct a computer to perform massive numbers of these simple operations give the illusion that the computer is doing something sophisticated. What is perceived by the user as a new or improved capability of a computer system is made possible by performing essentially the same set of very simple operations, but doing it much faster. Therefore continuing improvements to computer systems require that these systems be made ever faster.

The overall rate at which a computer system performs day-to-day tasks (also called “throughput”) can be increased by making various improvements to the computer's hardware design, which in one way or another increase the average number of simple operations performed per unit of time. The overall speed of the system can also be increased by making algorithmic improvements to the system design, and particularly, to the design of software executing on the system. Many algorithmic improvements to software increase the throughput not by increasing the average number of operations executed per unit time, but by reducing the total number of operations which must be executed to perform a given task. Algorithmic improvements might also increase throughput by optimum management of the concurrent use of hardware resources, so as to avoid both excessive idleness of resources and excessive contention for resources. Many such improvements are individually subtle in their effects, yet the cumulative effect of numerous small improvements to system performance can produce enormously increased system throughput.

Virtually all large computer systems contain multi-tasking operating systems which manage the allocation of system resources among multiple tasks or processes performing applications for users. For example, such operating systems manage dispatching to one or more CPUs, the allocation of memory address spaces, the assignment of portions (“pages”) of real memory, and so forth. Among the functions of the operating system are the initialization and termination of software processes.

Initialization of a software process generally requires that certain data structures for maintaining the state of the process and other information be created and initialized. At process termination, these data structures are generally no longer needed, and the address space occupied by the data structures is recycled and reused, using any of various techniques. Maintenance of such data structures is generally performed by the operating system.

In many operating systems, these data structures include a special data structure for recording certain events occurring during execution of the process. These event records can be used in the execution of the process itself, but are more typically maintained for diagnostic purposes. I.e., by recording a sequence of events transpiring as a result of execution of a process, it is possible to reconstruct the causes of unexpected behavior. Such information could be useful for analyzing program performance and resource utilization, debugging error conditions, and so forth.

During process execution, it is normally desirable to maintain event records in a form convenient for use by the operating system and/or executing process, and to minimize the amount of memory space required for recording events. For example, event records may be encoded as numbers which represent an event type, a program location at which the event occurred, and other aspects of process state. These encodings may be convenient for the operating system or executing process to provide and store, although they are relatively difficult for a human user to understand. In order to provide event data in a form that can be readily understood by human users, the system will typically convert the event record data structure maintained during program execution to an event log formatted for human-readable output. Conversion is often performed at the conclusion of process execution, although for some processes it may be performed periodically during execution. The event record data structure maintained during program execution is normally deleted after the human-readable log is generated.

Under normal operating conditions, generation of an event log formatted for human-readable output from the run-time event record data structure causes a small but manageable additional workload for the system. However, in some circumstances, generation of the human-readable event log creates a significant burden. Specifically, a large number of processes may terminate at approximately the same time, as a result of some system abnormality or a shutdown of the system. If a large number of processes need to generate respective human-readable event logs, the simultaneous generation of many event logs can cause contention for certain critical resources and a significant delay in response. Furthermore, generation of many event logs can temporarily increase the demand for memory, because both the run-time event record and the human-readable event log exist simultaneously. Where critical system abnormalities have occurred, the contention, increased memory demand, and delay in generating event logs may even have collateral consequences which aggravate the abnormality or affect the ability to diagnose and recover from the abnormality. For example, where the system is shut down because memory utilization is nearing capacity, the extra memory demand from generating human-readable event logs can actually cause the memory demand to exceed capacity, having very undesirable consequences.

Conventional operating systems allow the user to specify ahead of time whether a human-readable event log is to be generated, and even to specify that such a log should be generated in the presence of certain pre-specified conditions. However, it is difficult to anticipate all possible conditions under which such a log may be useful. Users often specify that the log should be generated in all cases so that the event log is available in case it should be needed.

A need therefore exists, not necessarily recognized, for improved techniques for generating human-readable event logs, and particularly improved techniques which will reduce the burden of generating large numbers of event logs responsive to terminating many processes nearly simultaneously.

### SUMMARY OF THE INVENTION

Data structures which maintain event records for executing processes are maintained in a persistent form after the process which created each respective such event record data structure is terminated. The event record data structures are eventually deleted, preferably by an automated process which de-allocates or otherwise cleans up the memory space used by the event record data structures after a pre-specified time period. A log formatted in human-readable form is generated, if at all, on demand of a user after completion of the process, and before deletion of the event record.

By maintaining the run-time event record data structure in persistent form after process termination, the decision to generate a human-readable log from the event records is deferred. In many cases, no such log will ever be needed, and the run-time event records will be deleted in due course without the need to generate a human-readable log. Furthermore, where numerous processes terminate nearly simultaneously, it is not necessary to generate any human-readable logs immediately, even if such logs are eventually desired. Thus contention and memory utilization issues arising from the simultaneous generation of many human-readable logs is avoided. The logs which are actually needed (usually a small subset of the total) can be generated at a later time.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a computer system for executing processes and managing event logs for executed processes, according to the preferred embodiment of the present invention.

FIG. 2 is a conceptual illustration of the major software components of a computer system for executing processes and managing event logs for executed processes, according to the preferred embodiment.

FIG. 3 is a conceptual representation of a typical persistent job information data structure, including an event log, and a corresponding job log which might be derived from it, according to the preferred embodiment.

FIG. 4 is a flow diagram illustrating at a high level the process of executing a job and recording events in the event log, according to the preferred embodiment.

FIG. 5 is a flow diagram showing a separate and asynchronous process for ordering a job log after job completion, according to the preferred embodiment.

FIG. 6 is a flow diagram showing a separate and asynchronous process to generate job logs from event logs, according to the preferred embodiment.

FIG. 7 is a flow diagram showing a separate and asynchronous process for de-allocating event logs which are no longer needed, according to the preferred embodiment.

### DETAILED DESCRIPTION OF THE PREFERRED EMBODIMENTS

As used herein, a “process” or “software process” is a single instance of execution of a set of instructions (such as a computer program, procedure or function), and has associated with it a state. Multiple processes representing respective instances of execution of the same program, procedure or function may be active simultaneously, each having its own respective state which is independent of the states of the other such processes. A process may spawn multiple paths or threads of execution, although many processes involve only a single thread of execution. A “process” may, in some system environments, be called a “job”, “task”, or by some other name, and unless otherwise limited by the context herein, the term “process” generally encompasses any or all such constructs, however named. Because the IBMi/Series™ computer system of the preferred embodiment generally employs the term “job”, that term has been used extensively herein; however, no distinction is made between a “process” and a “job”

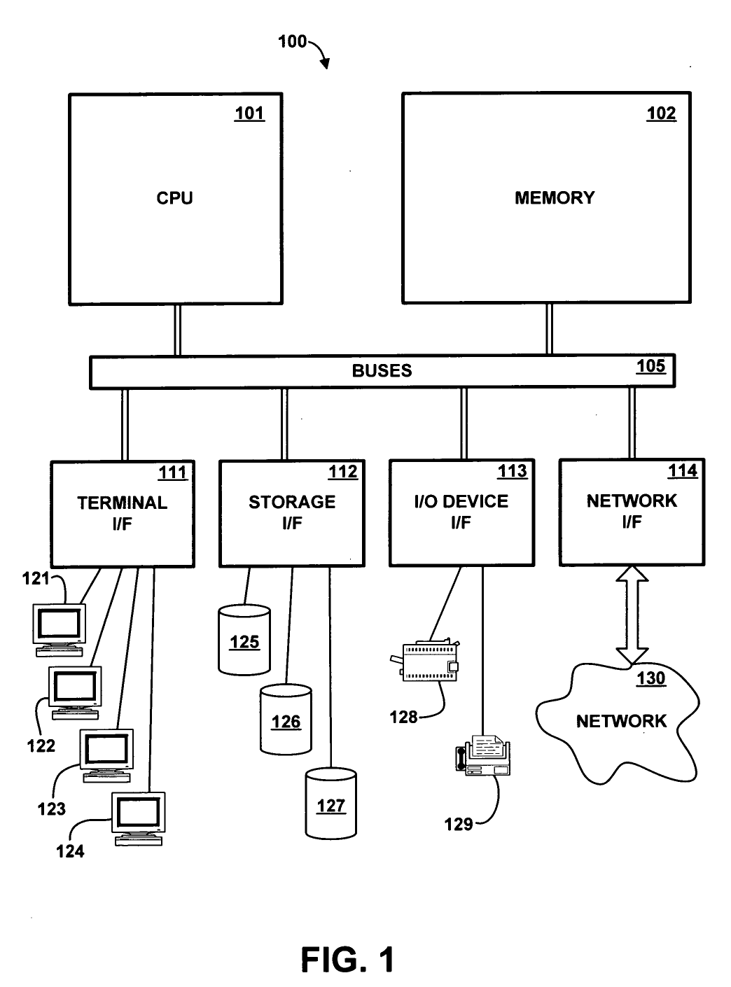

Referring to the Drawing, wherein like numbers denote like parts throughout the several views, FIG. 1 is a high-level representation of the major hardware components of a computer system 100 for executing processes and managing event logs for executed processes, according to the preferred embodiment of the present invention. CPU 101 is at least one general-purpose programmable processor which executes instructions and processes data from main memory 102. Main memory 102 is preferably a random access memory using any of various memory technologies, in which data is loaded from storage or otherwise for processing by CPU 101.

One or more communications buses 105 provide a data communication path for transferring data among CPU 101, main memory 102 and various I/O interface units 111-114, which may also be known as I/O processors (IOPs) or I/O adapters (IOAs). The I/O interface units support communication with a variety of storage and I/O devices. For example, terminal interface unit 111 supports the attachment of one or more user terminals 121-124. Storage interface unit 112 supports the attachment of one or more direct access storage devices (DASD) 125-127 (which are typically rotating magnetic disk drive storage devices, although they could alternatively be other devices, including arrays of disk drives configured to appear as a single large storage device to a host). I/O device interface unit 113 supports the attachment of any of various other types of I/O devices, such as printer 128 and fax machine 129, it being understood that other or additional types of I/O devices could be used. Network interface 114 supports a connection to an external network 130 for communication with one or more other digital devices. Network 130 may be any of various local or wide area networks known in the art. For example, network 130 may be an Ethernet local area network, or it may be the Internet. Additionally, network interface 114 might support connection to multiple networks.

It should be understood that FIG. 1 is intended to depict the representative major components of system 100 at a high level, that individual components may have greater complexity than represented in FIG. 1, that components other than or in addition to those shown in FIG. 1 may be present, and that the number, type and configuration of such components may vary, and that a large computer system will typically have more components than represented in FIG. 1. Several particular examples of such additional complexity or additional variations are disclosed herein, it being understood that these are by way of example only and are not necessarily the only such variations.

Although only a single CPU 101 is shown for illustrative purposes in FIG. 1, computer system 100 may contain multiple CPUs, as is known in the art. Although main memory 102 is shown in FIG. 1 as a single monolithic entity, memory 102 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although communications buses 105 are shown in FIG. 1 as a single entity, in fact communications among various system components is typically accomplished through a complex hierarchy of buses, interfaces, and so forth, in which higher-speed paths are used for communications between CPU 101 and memory 102, and lower speed paths are used for communications with I/O interface units 111-114. Buses 105 may be arranged in any of various forms, such as point-to-point links in hierarchical, star or web configurations, multiple hierarchical buses, parallel and redundant paths, etc. For example, as is known in a NUMA architecture, communications paths are arranged on a nodal basis. Buses may use, e.g., an industry standard PCI bus, or any other appropriate bus technology. While multiple I/O interface units are shown which separate buses 105 from various communications paths running to the various I/O devices, it would alternatively be possible to connect some or all of the I/O devices directly to one or more system buses.

Computer system 100 depicted in FIG. 1 has multiple attached terminals 121-124, such as might be typical of a multi-user “mainframe” computer system. Typically, in such a case the actual number of attached devices is greater than those shown in FIG. 1, although the present invention is not limited to systems of any particular size. User workstations or terminals which access computer system 100 might also be attached to and communicate with system 100 over network 130. Computer system 100 may alternatively be a single-user system, typically containing only a single user display and keyboard input. Furthermore, while the invention herein is described for illustrative purposes as embodied in a single computer system, the present invention could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 100 is a computer system based on the IBM i/Series™ architecture, it being understood that the present invention could be implemented on other computer systems.

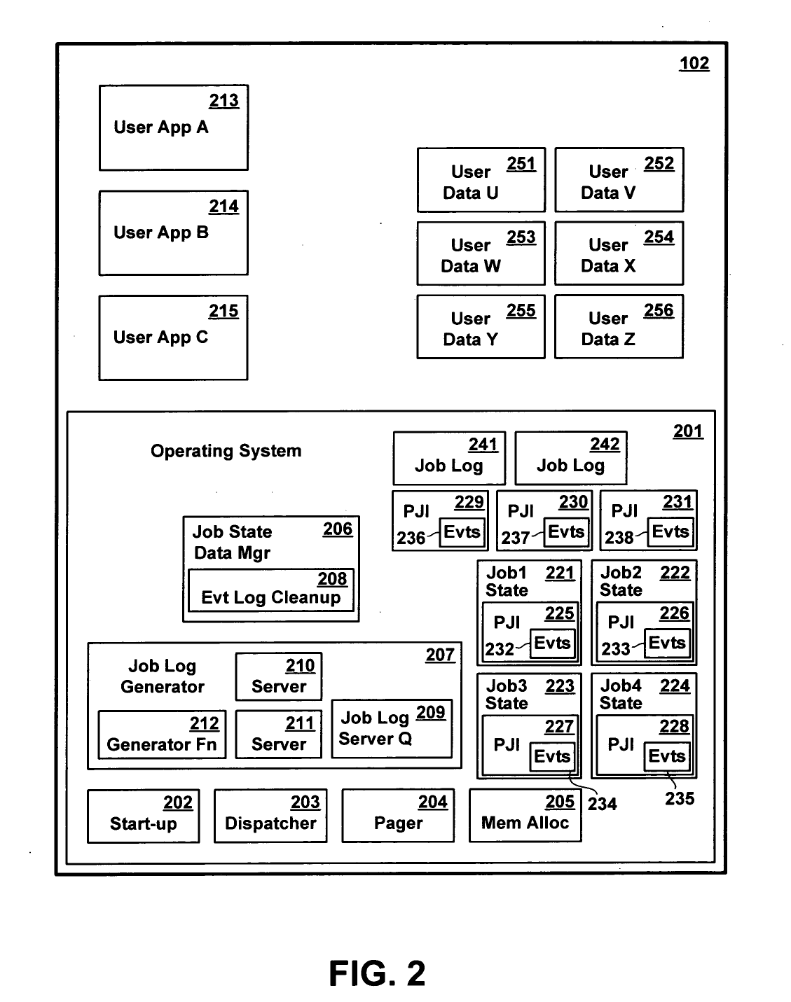

FIG. 2 is a conceptual illustration of selective significant software components of system 100 in memory 102. Operating system 201 is executable code and state data providing various low-level software functions, such as device interfaces, management of memory pages, management and dispatching of multiple tasks, etc. as is well-known in the art. In particular, operating system 201 maintains certain state data structures for multiple jobs including event record data structures, and in appropriate circumstances generates human-readable event log data, as herein explained.

Referring to FIG. 2, operating system 201 includes a system initialization function 202, a dispatching function 203, a real memory paging function 204, a virtual memory allocation function 205, a job state management function 206, and a job log generation function 207. System initialization function 202, dispatching function 203, real memory paging function 204, and virtual memory allocation function 205 are shown conceptually as single respective blocks without further detail; job state management function 206 and job log generation function 207 are shown in limited detail. However, it will be understood that these are in fact complex entities having respective internal code and state data structures, not all of which are depicted in the representation of FIG. 2. It will further be understood that operating system 201 includes many other functions too numerous to mention, as is known in the art.

Operating system 201 includes various state data, and in particular state data for recording the state of jobs active in the system. A respective set of operating system job state data structures 221-224 is maintained for each job. Four operating system job state data structures 221-224 are shown by way of example in FIG. 2, it being understood that the actual number present on the system at any time may vary, and is typically much larger. This job state data 221-224 may include data such as a job identifier, user, authorities, memory allocations, current execution state, and various other data needed by the operating system. Some of the operating system job state data (herein referred to as “job execution state data”) is temporary and disappears (is de-allocated, recycled, or otherwise deleted) upon job termination, but a subset of the operating system job state data, herein referred to as “persistent job information” 225-229, comprises one or more respective data structures which are persistent and can last indefinitely beyond job termination (although these are generally periodically cleaned up by a separate asynchronous process). Among the data included in the persistent job information portion of the operating system job state is event record data (referred to herein as an “event log data structure” or “event log”) 232-235, which records events that have occurred during execution of the corresponding job. Job state data structures 221-224 corresponding to respective jobs are shown conceptually in FIG. 2 as monolithic entities which include the corresponding persistent job information 225-228 and event log data structures 232-235. However, it will be understood that this representation is not meant to imply that all job state data is maintained at contiguous memory locations. Job state data is typically maintained in multiple data structures, and that there may be references, such as pointers, identifying various portions of the job state data. In particular, the event log data structure preferably occupies a separate range of memory addresses.

In the preferred embodiment, it is possible for some event log data structures to survive in the operating system as part of the persistent job information after the job has completed and job execution state data has been de-allocated or recycled for use by other jobs. FIG. 2 represents three persistent job information data structures 229-231 containing respective event log data structures 236-238, which are not associated with any job execution state data. In the preferred embodiment, event log data structures 232-239 are persistent data structures, meaning that they survive a system power-down and re-initialization.

Job state data management function 206 allocates, initializes and deallocates respective operating system job state data structures 221-224, including event logs 232-239, for each of multiple jobs. In particular, event logs which persist long after the corresponding jobs have completed and the job execution state data structures have been de-allocated or recycled are periodically de-allocated using event log cleanup function 208. Certain operations of job state data management function 206 are described in greater detail herein.

Each event log data structure 232-239 contains a record of events occurring during execution of the corresponding job. Events may include, for example, procedure or function calls, interrupts, error conditions, trace or break points encountered, and so forth. The user, system administrator or other person may specify by any of various means the type of events or conditions on which events should be recorded in the event log, as is known in the art, and this specification may vary from job to job. Events are added to the event log as the corresponding job executes, and the data in each event log is accordingly maintained in a format convenient for use by the operating system, not necessarily easily readable by a human user. In some cases, a human-readable form of the event records in the event log data structure, referred to as a “job log” 241-242, is generated by job log generator 207. FIG. 2 represents two job logs 241-242, it being understood that the number may vary. Job log generator includes generation function code 212, one or more job log servers 210-211 (of which two are shown in FIG. 2), and a job log server queue 209. Job log server queue 209 contains references to event logs for which job logs are to be generated. Job log servers 210-211 are special-purpose operating system jobs for generating job logs from event log references enqueued on job log server queue 209. Each server 210-211 is an instantiation of common job log generation function code 212 and other functions as required. The operation of job log generator 207 is described in greater detail herein.

In addition to various operation system entities, system 100 typically contains one or more user applications 213-315 (of which three are shown in FIG. 2). Such user applications may execute entirely on computer system 100, or may access functions in remote systems through a network. Such user applications may include, e.g., personnel records, accounting, code development and compilation, mail, calendaring, web browsing, or any of thousands of user applications. System 100 further includes various user data objects for maintaining user data 251-256 (of which six are shown in FIG. 2), it being understood that the actual number of such entities may vary, and in particular the number of user data objects is typically much larger. User data objects 251-256 contain data which is maintained by the user applications themselves, and is to be distinguished from operating system state data 221-224 which is maintained by the operating system in order to track executing jobs and so forth.

Various software entities are represented in FIG. 2 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representation of FIG. 2, it will be understood that the actual number of such entities may vary, and in particular, that in a complex system environment, the number and complexity of such entities is typically much larger.

While the software components of FIG. 2 are shown conceptually as residing in memory 102, it will be understood that in general the memory of a computer system will be too small to hold all programs and data simultaneously, and that information is typically stored in data storage devices 125-127, comprising one or more mass storage devices such as rotating magnetic disk drives, and that the information is paged into memory by the operating system as required. Furthermore, it will be understood that the conceptual representation of FIG. 2 is not meant to imply any particular memory organizational model, and that system 100 might employ a single address space virtual memory, or might employ multiple virtual address spaces which overlap.

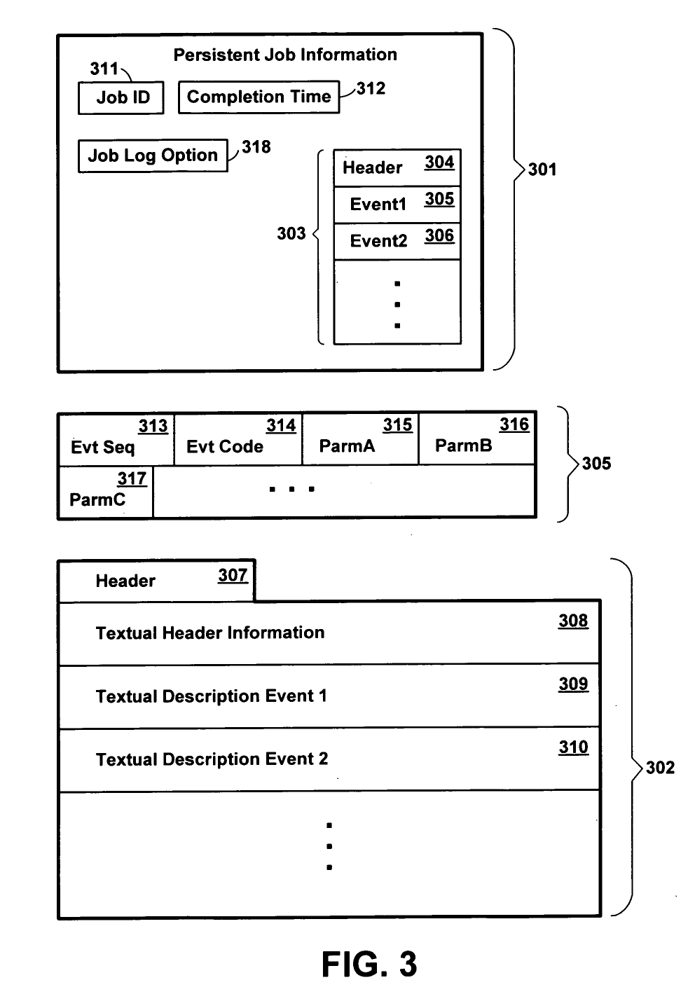

FIG. 3 is a conceptual representation of a typical persistent job information data structure 301, including an event log data structure 303, and a corresponding job log 302 which might be derived from it, according to the preferred embodiment. Persistent job information 301 is represented conceptually at a very high level, showing only certain components relevant to the present invention, it being understood that persistent job information 301 may include additional state data not shown. Persistent job information includes an event log 303, a job identifier 311 which uniquely identifies the job to which the persistent job information corresponds, a completion timestamp 312 which identifies the time and date upon which the corresponding job completed execution, and a job log option 318 which specifies action to be taken relative to generating a job log from the event record, as explained further herein.

Event log 303 contains a header 304 and one or more event entries 305-306 (of which two are shown in FIG. 3, it being understood that the number may vary, and is typically larger). For some jobs, it is possible that the number of event records will exceed the virtual memory allocation for the event log. In this case, the event records typically wrap and overwrite older event records in the event log. If it is desired to preserve all event records in a job where event records are overwritten, it is possible to trigger generation of a job lob from the event records when the event log is filled.

Event log header 304 includes any of various data which might be useful in identifying the state of the corresponding job itself, format of the event log, or similar parameters, as opposed to particular events occurring during job execution. Each event record or entry 305-306 in event log 301 records a single corresponding event occurring during execution of the corresponding job. The event record contains several fields for entry of data in a manner convenient for use by the operating system. These fields are not formatted for human-readable output (although it is possible that someone with intimate knowledge of the fields and their meaning could read them in the raw form in which they are stored in the event log). For example, fields in an event entry 305-306 might include an event sequence 313, an event code 314, and a variable number of event parameters 315-317 (of which three are shown). Event sequence 313 is a value which correlates to the relative chronological order of the event vis-a-vis other events. It could be, e.g., a timestamp, an instruction counter, a sequence number which is incremented with each event, or some similar quantity. Event code 314 is an encoded value representing a type of event. Event parameters 315-317 represent additional information with respect to the event (e.g., a state of some key program variable, a code location at which the event occurred, etc.). The number of parameters may vary depending on the type of event or other factors.

Job log 302 is a record derived from an event log 301, and is intended as a human-readable formatting of the information in the corresponding event log from which it was derived. In general, job log 302 is larger than the corresponding event log from which it is derived, although in rare cases this might not be so. Job log 302 contains a non-readable header 307, a textual header 308, and one or more textual event descriptions 309-310 (of which two are shown in FIG. 3, it being understood that the number may vary, and is typically larger), each of the textual event descriptions 309-310 corresponding to a respective event record 305-306 in the event log 301 from which the job log 302 was derived.

Header 307, which is not intended for display to a user, contains any data necessary for the maintenance of the job log record 302. For example, non-readable header may contain a job identifier, a length of the job log record, a text formatting convention used, and similar information. Textual header 308 contains textual information intended for display to a human user, and descriptive of the corresponding job and/or event record as a whole. Each textual event description 309-310 contains a description of a corresponding event occurring during execution of the job. The textual event description is derived from the corresponding event record in the event log according to some pre-established translation rules. For example, an event code 314 might be a numerical code which indexes a textual description and formatting of the event in a table of event codes (not shown), the textual description being included in textual event description 309-310. Parameters 315-317 might similarly references other textual information, or might be included a textual description from an event code to fill in blanks in the description

In accordance with the preferred embodiment of the present invention, in at least one operating mode the generation of a job log from a corresponding event log is deferred when the job completes. The state execution data for the job may be de-allocated, except that the event log data structure persists. The event log data structures which persist in this fashion are periodically cleaned up by an separate, asynchronous cleanup function. The interval between job completion and cleanup is selected to be sufficiently long so that a user can determine the desirability of creating a job log, and order one if he so wishes. If the user orders a job log before the event log is deallocated, a job log is appropriately generated from the event log. If not, the event log is deleted after the cleanup interval and it is no longer possible to generate the job log. This process is shown and described in greater detail in the flow diagrams which follow.

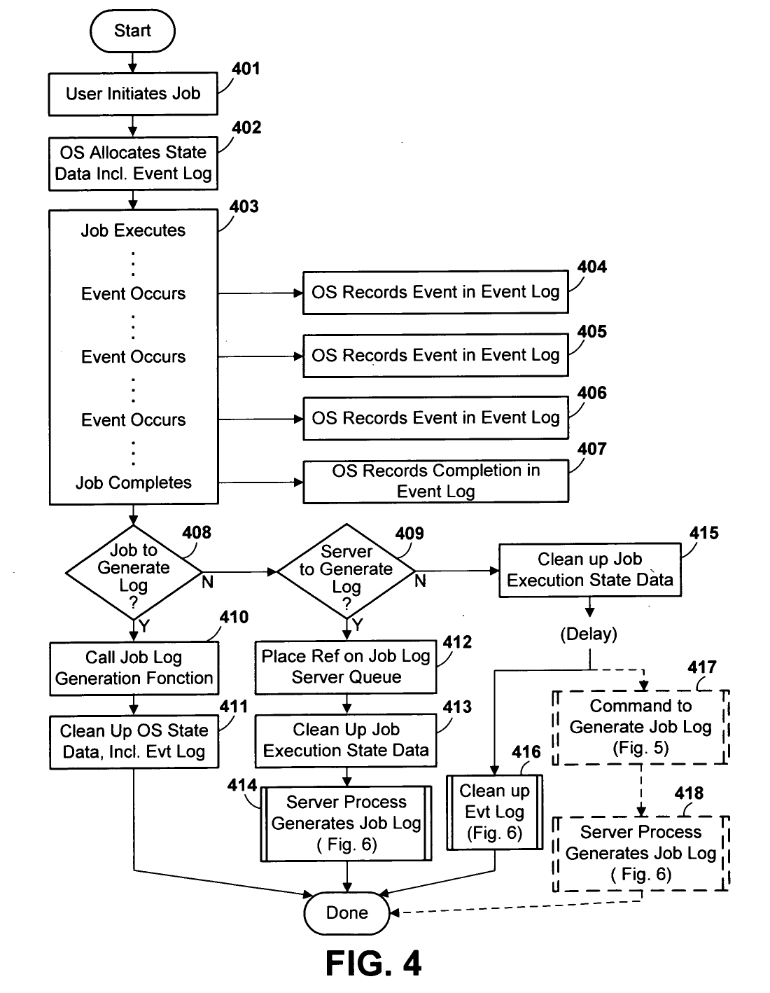

FIG. 4 is a flow diagram illustrating at a high level the process of executing a job and recording events in the event log, according to the preferred embodiment. Referring to FIG. 4, a job is initiated by or on behalf of a user using any of various conventional techniques, shown generally as step 401. In response to initiating a job, the operating system allocates certain state data structures for the new job, including in particular an event log for recording events occurring during execution (step 402). At some point, a job becomes active and execution of user work (e.g., a user application program) commences. There may be a time lag between initiation of the job and commencement of active execution of user work; preferably, persistent job information 301, including the event log 303, is allocated at or near initiation of the job, although certain other state data, such as job execution state data, may not be allocated until the job becomes or is ready to become active.

Execution of user work is represented generally as step 403. It will be understood that execution of the user work is not necessarily continuous. Typically, a job shares CPU and other resources with other jobs in a multi-tasking system. The job may wait on a ready queue in the dispatcher 203 for an available CPU, be dispatched when a CPU is available for execution, execute in the CPU until some latency event (such as a storage access) occurs or the job is pre-empted by another job, be placed on a wait queue if necessary to wait on a latency event, and return to the ready queue when again ready to execute. This process may repeat many times, as is well known in the art. Step 403 represents generally the entire period between activation of the job (commencement of user work) and completion of the user work, in which the job is intermittently executing. During this period, various events may occur which should be recorded in event log 301. Each such event causes the operating system to record the event in the event log by appending an appropriate event record 305, 306 to the event records contained in the event log (steps 404, 405, 406). Although three such events are represented in FIG. 4, it will be understood that the number of such events may vary, and is frequently much larger. Furthermore, although events are represented in FIG. 4 as occurring as are result of execution of user work, as is typically the case, it is possible in some environments for recordable events to occur outside the context of the job, and even to occur after execution of user work has completed.

At some point, the execution of user work completes (end of step 403). The user work may complete normally, or may end execution as a result of some non-recoverable error. In either case, the operating system also records completion of the user work as an event in the event log (step 407), there preferably being multiple job completion codes to indicate whether the user work completed normally or otherwise.

Upon completing execution of user work, the operating system may generate a human-readable job log from the event log data, depending on the state of certain job log generation options. In the preferred embodiment, one of three options may be selected as explained below, of which the third option is particularly significant. Selection of a job log option is specified in job log option field 318; this value is set at job initiation, and can in some circumstances be altered later (e.g., under program control during job execution). Preferably, one of the options is a default, and the user may override the default by so specifying at job initiation. The options are provided in the preferred embodiment to give the user maximum flexibility and for compatibility with legacy systems; however, in an alternative embodiment, it would not be necessary to have options, and “third option” described below could be used in every case.

In a first option, represented as the ‘Y’ branch from step 408, completion of user work immediately triggers a call to a job log generation function 212 in the operating system on behalf of the job itself (step 410). The job log generation function generates the job log from the event log, and the operating system then de-allocates or otherwise cleans up the operating systems state data, including the event log (step 411).

In a second option, represented as the ‘Y’ branch from step 409, the generation of a job log is handled by a separate server process. Specifically, data for generating a job log (such as a pointer to the event log) is placed on job log server queue 209 (step 412). After placing the data on the job log server queue, the operating system deallocates or otherwise cleans up the operating system job execution state data, but not the persistent job information 301, which includes the event log 303 (step 413). Placing a reference to the event log on the server queue at step 412 causes a separate, asynchronous server process 210, 211 to eventually pull the reference off the queue and call the job log generation function 212 to generate the job log. This separate server process is represented in FIG. 4 as step 414, and is shown in greater detail in FIG. 6. Although FIG. 4 represents the deallocation of data (step 413) occurring before the server process (step 414), it will be understood that, the server process being asynchronous, these steps could occur concurrently, or the server could generate the job log before the operating system cleans up job execution state data.

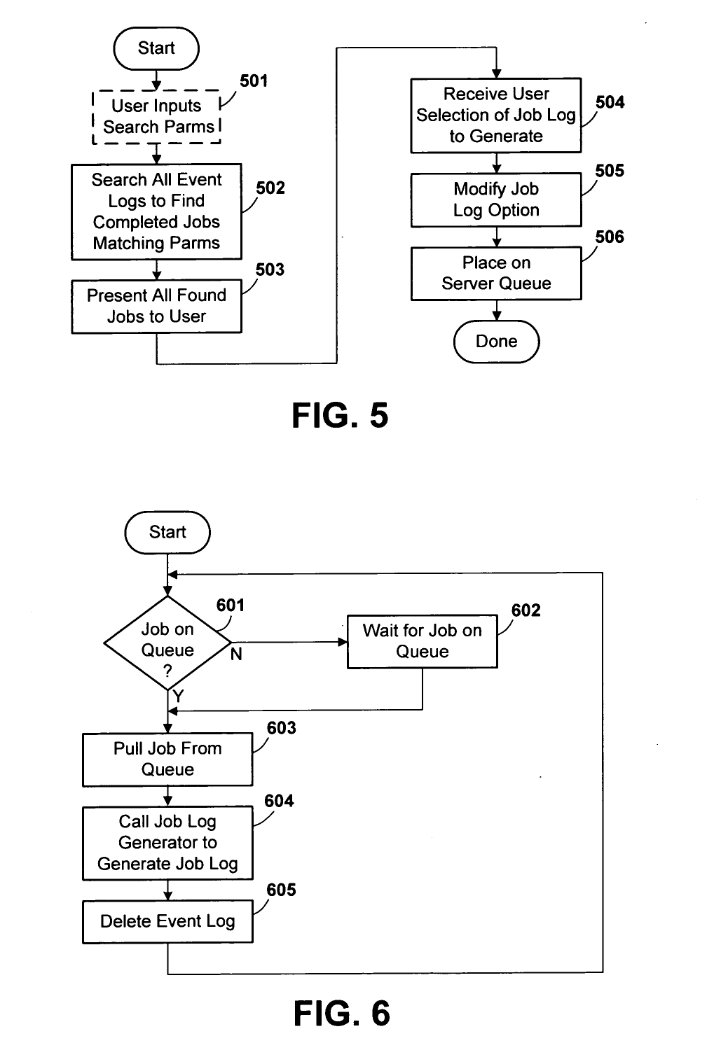

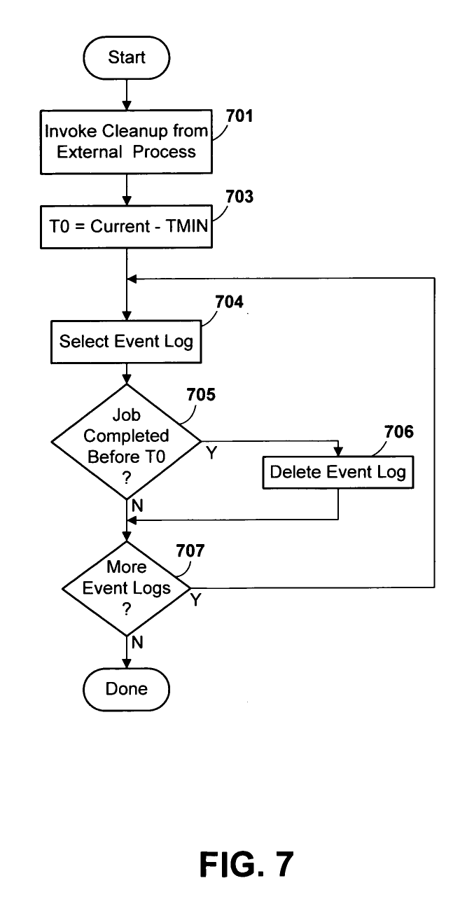

In a third option, represented as the ‘N’ branch from step 409, generation of a job log is deferred until appropriately requested, and in most cases no job log is generated at all. In this option, the operating system immediately deallocates or otherwise cleans up the operating system job execution state data, but not the persistent job information 301, which includes the event log 303 (step 415). The job execution state data being no longer present, no further action is performed on behalf of the job. However, after some interval of time, a separate asynchronous event log cleanup process 208 will de-allocate or otherwise clean up the event log; this separate process is represented in FIG. 4 as step 416, and is shown in greater detail in FIG. 7. During the time interval between steps 415 and 416, a user, system administrator or the like may order the generation of a job log from the event log, causing the data for generating a job log to be placed on the job log server queue. This is accomplished by a separate process represented in FIG. 4 as step 417, and shown in greater detail in FIG. 5. Placement on the server queue eventually causes an asynchronous server process 210, 211 to generate a job log, represented in FIG. 4 as step 418, and shown in greater detail in FIG. 6.

FIG. 5 is a flow diagram showing a separate and asynchronous process for ordering a job log for a job after completion, when the job log was initially deferred and not generated upon job completion, according to the preferred embodiment. I.e., the process of FIG. 5 is separate from and independent of the job for which the job log is being ordered, and may occur any time after job completion. The process of FIG. 5 may in fact be used to order multiple job logs at approximately the same time. A job lob must be ordered using the process of FIG. 5 before the event log has been deleted by event log cleanup function 208, but there is otherwise no restriction as to time interval between job completion and ordering the job log.

Referring to FIG. 5, upon invoking a process to select one or more job logs to be generated, a user optionally inputs search parameters for finding applicable event logs, i.e. event logs from completed jobs, for which a job log has not yet been generated (step 501). Step 501 is optional because the scope of a search may be implied or fixed by default; e.g., it might be all jobs executed on behalf of the requesting user. In response to any search criteria input at step 501 or any default criteria, the operating system finds all event logs for which: (a) the applicable job has already completed, and (b) the generation of a job log was deferred at job completion, and (c) generation of a job log has not yet been ordered by placing a reference to the event log on job log server queue 209 (step 502). The jobs corresponding to these event logs are then presented to the user, preferably by listing certain identifying particulars on an interactive display screen (step 503). The user may then select a job from the displayed jobs (step 504). In response to the user's selection, the value of the job log option 318 is changed to specify that the job log server generates a job log (step 505); this is done to support recovery of a job log server queue if the data therein should be lost. A reference to the event log corresponding to the selected job is then placed on job log server queue 209 (step 506). The process of selecting and ordering job logs goes no further than to place data on the job log server queue and change the value of the job log option. A job lob server process shown in FIG. 6 does the rest.

FIG. 6 is a flow diagram showing a separate and asynchronous process performed by a job log server 210, 211 to generate job logs from event logs, according to the preferred embodiment. Referring to FIG. 6, if there is no event log reference on the job log server queue 209 (the ‘N’ branch from step 601), the job log server waits for event log reference on the job log server queue (step 602). When a reference is available, the job log server pulls the reference from the job log server queue, removing it from the queue (step 603). The job log server then invokes the operating system's job log generation function 212 to generate a job log from the event log for which the reference was pulled (step 604). After the job log has been generated, the job log server deletes the event log, i.e., it de-allocates, recycles or otherwise cleans up the event log data structure, allowing the allocated address space to be re-used (step 605). The job log server then returns to step 601 to pull another event log reference from the job log server queue, or to wait if none is available. The job log server process continues indefinitely, and is only halted by intervention by a system administrator or similar person, unusual error condition, or the like. In the preferred embodiment, there may be multiple active job log server processes on the system, each concurrently generating job logs, but only one job log server queue 209 from which all job log server processes obtain event logs to be used as sources for the job logs.

FIG. 7 is a flow diagram showing a separate and asynchronous process performed by Event log cleanup function 208 for de-allocating event logs which are no longer needed, i.e., after some sufficient time interval has passed since job completion that the user has had ample opportunity to order a job log if one is desired, according to the preferred embodiment. Referring to FIG. 7, an event log cleanup process is periodically invoked automatically from an external process (step 701). As is known, various cleanup functions can be periodically invoked according to some schedule, the period varying according to the type of function. The precise mechanism for invoking a cleanup function may vary, and the event log cleanup process could be invoked from multiple different operating system processes. An event log cleanup function is typically invoked after a relatively long interval (e.g., 24 hours) compared with most system processes.

Upon the occurrence of some event (such as expiration of an external timer) causing the cleanup function to be invoked, the cleanup process begins execution. A threshold time T₀ is established as the current system time less the minimum interval T_{MIN} (step 703). The process then selects each event log in turn (step 704). If the job corresponding to the selected event log completed before time T₀, then the ‘Y’ branch is taken from step 705, and the selected event log is de-allocated or otherwise cleaned up so that the memory addresses it occupies are available for re-use by other processes (step 706). If the corresponding job completed after time T₀ or has not yet completed, the ‘N’ branch is taken from step 705, and no action is taken. If there are more event logs to be examined, the ‘Y’ branch is then taken from step 707, and a next event log is selected at step 704. When all event logs have been examined, the ‘N’ branch is taken from step 707, and the cleanup process terminates.

The minimum interval T_{MIN} is set sufficiently long so that a user will have time to receive output from the job, recognize the need, if any, for a job log, and order the generation of a job log, as described above, before the event log can be de-allocated. This interval is not necessarily (although could be) the same as the length of the interval at which the event log cleanup process executes. For example, a suitable T_{MIN} interval might be 7 days. After de-allocation of the event log, it is impossible to generate the job log.

Among the advantages of the technique described herein as a preferred embodiment is the fact that the decision to generate a job log is deferred until after the job completes, when more complete information is available to the user regarding the need for a job log. In most cases, it is expected that no job log will be generated, and the event log will eventually be de-allocated without the need to ever generate a job log. Furthermore, certain events which normally cause many jobs to end simultaneously (such as system shut-down or certain error conditions) do not automatically cause these jobs to generate respective job logs, thus avoiding a condition in which access to job log generation resources is constrained. For example, certain critical code paths or data structures may require locks when generating job logs, causing a bottleneck when many job logs are being generated simultaneously. Additionally, during job log generation both the job log and the event log exist in memory, the event log normally being deleted after job log generation. The existence of both structures simultaneously for a large number of jobs may aggravate memory utilization problems.

In the preferred embodiment described above, the execution of a job and generation of job logs from an event log is described as a series of steps in a particular order, using particular independent processes. However, it will be recognized by those skilled in the art that the order of performing certain steps may vary, that some processes may be combined or further subdivided into other processes, and that variations in addition to those specifically mentioned above exist in the way particular steps or processes might be performed.

In the textual description above, cleaning up of memory allocated to a data structure has been variously referred to as deletion, de-allocation, recycling, and so forth. It will be understood that the exact operation used is dependent on the particular operating system involved, and that different systems will use different mechanisms. As used herein, no distinction is made among these various operations, and all are generally encompassed by the term “deletion”.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, volatile and non-volatile memory devices, floppy disks, hard-disk drives, CD-ROM's, DVD's, magnetic tape, and so forth. Furthermore, the invention applies to any form of signal-bearing media regardless of whether data is exchanged from one form of signal-bearing media to another over a transmission network, including a wireless network. Examples of signal-bearing media are illustrated in FIG. 1 as system memory 102, and as data storage devices 125-127.

Although a specific embodiment of the invention has been disclosed along with certain alternatives, it will be recognized by those skilled in the art that additional variations in form and detail may be made within the scope of the following claims:

What is claimed is:

1. A method for generating event records for processes executed in a computer system, comprising the computer-executed steps of:
(a) executing a plurality of process in a computer system;
(b) maintaining a respective event record data structure for each said executing process, each said event record data structure recording respective events occurring during execution of the corresponding process, each said event record data recording said respective events in an encoded format not intended for reading by a human user;
(c) maintaining each said event record data structure for a respective time interval after completion of the corresponding process, said time interval being sufficiently long for a human user to determine a need for a log of said events formatted in human-readable form;
(d) if a request to generate a log formatted in human-readable form from a said event record data structure is received from a human user after completion of the corresponding process and before expiration of said respective time interval, then automatically generating said log formatted in human-readable form responsive to said request; and
(e) if a request to generate a log formatted in human readable form from said event record data structure is not received from a human user after completion of the corresponding process and before expiration of said respective time interval, then automatically deleting said event record data structure.

2. The method of claim 1,
wherein said step of automatically deleting said event record data structure is performed by an asynchronous process which periodically examines said event record data structures and deletes any said event record data structures corresponding to processes which have completed earlier than a threshold time.

3. The method of claim 2,
wherein said threshold time is automatically computed as the difference between a current time and a user-specified minimum time to wait before deletion of a said event record data structure.

4. The method of claim 1, wherein said step of automatically generating said log formatted in human-readable form comprises:
placing a reference to the event record data structure on a queue for generating logs formatted in human-readable form; and
removing said reference from said queue and generating said log formatted in human-readable form in an asynchronous log generation process.

5. The method of claim 1, further comprising the steps of:
with respect to a plurality of said processes executed on said computer system, receiving a respective specification whether to defer generation of a respective log formatted in human-readable form upon process completion, said receiving step being performed before execution of the corresponding process;
with respect to each process for which a specification is received to defer generation of a respective log formatted in human-readable form, performing said steps (d) and (e); and
with respect to each process for which a specification is received to not defer generation of a respective log formatted in human-readable form, automatically generating a respective log formatted in human-readable form upon completion of the corresponding process.

6. A computer program product for generating event records for processes executed in a computer system, comprising:
a plurality of computer-executable instructions recorded on signal-bearing media, wherein said instructions, when executed by at least one computer system, cause the at least one computer system to perform the steps of:
(a) maintaining a respective event record data structure for each of a plurality of processes executing in said computer system, each said event record data structure recording respective events occurring during execution of the corresponding process, each said event record data recording said respective events in an encoded format not intended for reading by a human user;
(b) maintaining each said event record data structure for a respective time interval after completion of the corresponding process, said time interval being sufficiently long for a human user to determine a need for a log of said events formatted in human-readable form;
(c) if a request to generate a log formatted in human-readable form from a said event record data structure is received from a human user after completion of the corresponding process and before expiration of said respective time interval, then automatically generating said log formatted in human-readable form responsive to said request; and
(d) if a request to generate a log formatted in human readable form from said event record data structure is not received from a human user after completion of the corresponding process and before expiration of said respective time interval, then automatically deleting said event record data structure.

7. The computer program product of claim 6,
wherein said step of automatically deleting said event record data structure is performed by an asynchronous process which periodically examines said event record data structures and deletes any said event record data structures corresponding to processes which have completed earlier than a threshold time.

8. The computer program product of claim 7,
wherein said threshold time is automatically computed as the difference between a current time and a user-specified minimum time to wait before deletion of a said event record data structure.

9. The computer program product of claim 6, wherein said step of automatically generating said log formatted in human-readable form comprises:
placing a reference to the event record data structure on a queue for generating logs formatted in human-readable form; and
removing said reference from said queue and generating said log formatted in human-readable form in an asynchronous log generation process.

10. The computer program product of claim 6, further comprising the steps of:
with respect to a plurality of said processes executed on said computer system, receiving a respective specification whether to defer generation of a respective log formatted in human-readable form upon process completion, said receiving step being performed before execution of the corresponding process;
with respect to each process for which a specification is received to defer generation of a respective log formatted in human-readable form, performing said steps (c) and (d); and
with respect to each process for which a specification is received to not defer generation of a respective log formatted in human-readable form, automatically generating a respective log formatted in human-readable form upon completion of the corresponding process.

11. The computer program product of claim 16, wherein said computer program product comprises an operating system, said operating system further including at least one dispatching function, at least one real memory paging function and at least one virtual memory allocation function.

12. A computer system, comprising:
at least one processor;
a memory for storing data including computer programs executable on said at least one processor;
an operating system which maintains process state data for a plurality of processes executing on said at least one processor, said process state data including a respective event record data structure for each of a plurality of said executing processes, each said event record data structure recording respective events occurring during execution of the corresponding process, each said event record data recording said respective events in an encoded format not intended for reading by a human user;
wherein said operating system further generates respective logs of said events recorded in each said event record data structure, wherein, for at least some said event record data structures, said operating system maintains the event record data structure for a respective time interval after completion of the corresponding process, said time interval being sufficiently long for a human user to determine a need for a log of said events formatted in human-readable form, and (a) automatically generates said log formatted in human-readable form responsive to a request received from a human user after completion of the corresponding process and before expiration of said respective time interval, and (b) automatically deletes said event record data structure without generating said log formatted in human-readable form if no such request is received from a human user before expiration of said respective time interval.

13. The computer system of claim 12,
wherein said process state data includes execution state data and persistent state data, said execution state data being automatically deleted upon completion of execution of the corresponding process, said persistent state data persisting after completion of execution of the corresponding process, said persistent state data including said event record data structure.

14. The computer system of claim 12,
wherein said operating system includes a cleanup function which automatically deletes said event record data structures without generating corresponding said logs formatted in human-readable form if no corresponding said request is received from a human user before expiration of said respective time interval, said cleanup function periodically examining said event record data structures and deleting any said event record data structures corresponding to processes which have completed earlier than a threshold time.

15. The computer system of claim 14,
wherein said threshold time is automatically computed as the difference between a current time and a user-specified minimum time to wait before deletion of a said event record data structure.

16. The computer system of claim 12,
wherein said operating system comprises a queue for generating said logs formatted in human-readable form and at least one log generation function which obtains a reference to a process from said queue and, responsive to obtaining said reference, generates a said log formatted in human-readable form from the event record data structure corresponding to the referenced process.

17. The computer system of claim 12,
wherein said process state data further includes data specifying whether to defer generation of a respective log formatted in human-readable form upon process completion, said operating system automatically generating a respective log formatted in human-readable form upon completion of each process for which the data specifies that generation of a log formatted in human-readable form should not be deferred, and performing said steps (a) and (b) if the data specifies that generation of a log formatted in human-readable form should be deferred.
